(19) United States
(12) Patent Application Publication
(10) Pub. No.: US 2002/0194606 A1
(43) Pub. Date: Dec. 19, 2002

(54) System and method of communication between videoconferencing systems and computer systems

(76) Inventors: Michael Tucker, Austin, TX (US); Timothy Perry, Austin, TX (US)

Correspondence Address: CARR & FERRELL LLP, 2225 EAST BAYSHORE ROAD, SUITE 200, PALO ALTO, CA, 94303, US

(21) Appl. No.: 09/881,785

(22) Filed: Jun. 14, 2001

(51) Int. Cl. H04N 7/14; H04N 7/173

(52) U.S. Cl. 725/86; 348/14.08; 348/14.01

(57) ABSTRACT

A system and method that allows videoconferencing-formatted data to be viewed with standard media formats for computer systems. A processor interprets the header information contained in a videoconferencing-formatted data stream and reassembles the audio and video data into a standard media format. Although new headers are created, audio and video data are unmodified for the new format.

### BACKGROUND OF THE INVENTION

1) Field of the Invention

The invention relates generally to videoconferencing systems, and more particularly to communication between videoconferencing systems and computer systems.

2) Description of Background Art

FIG. 1 is a prior art diagram of a videoconferencing network which includes a videoconferencing endpoint 110, a network 120, a second videoconferencing endpoint 130, and possibly a remote terminal 140. Videoconferencing systems have become familiar, if not standard, equipment in many organizations. Connecting over networks 120 such as the integrated services digital network (ISDN), the public switched telephone network (PSTN) or the Internet, videoconferencing systems are used world-wide to allow people to conduct face-to-face meetings with others who are great distances away.

Each videoconferencing endpoint 110 or 130 usually consists of a videoconferencing unit, such as a Polycom® ViewStation FX, and a monitor, such as a television set or computer monitor. The videoconferencing unit has a camera to capture video data, a microphone to capture audio data and a processor to both format the data for outgoing transmission and interpret incoming data.

FIG. 2A is a prior art block diagram showing the inputs and outputs of a videoconferencing unit. The camera captures raw video 210 and the microphone captures raw audio 220. The processor 230 then formats the raw information 210 and 220 into data 240 that is understandable by other videoconferencing endpoints.

Specifically, the videoconferencing endpoints 110 and 130 communicate with each other through a real time transport protocol (RTP). Although RTP is a standard transport protocol for videoconferencing units, it is non-standard for computer systems. Standard media formats for computer systems include audio video interleave (AVI), QuickTime movie (MOV), RealMedia (RM), and MPEG, audio layer 3 (MP3). As used in this specification “standard media formats” means standard media formats for computer systems.

FIG. 2B is a prior art block diagram showing the organization of a RTP data stream 240. RTP data stream 240 is separated into frames of and header information 250, audio data 260, and video data 270. Typically, audio 260 and video data 270 is compressed by the processor 230 with common compression schemes, such as the video codec H.263, for faster transmission over network 120.

Referring back to FIG. 1, only systems that have the ability to interpret RTP data stream 240 can watch and listen to videoconferences. Although it is possible that some remote terminal 140 would have the capability to interpret and play RTP data, such systems are not common.

What is needed is a system or method that overcomes the disadvantages in the prior art.

### BRIEF SUMMARY OF THE INVENTION

The invention provides a system that includes a videoconferencing unit and a processor. For the purposes of this specification, the videoconferencing unit is a system or systems that capture audio and video information, and creates data in a format appropriate for a real time transport protocol. The processor receives the data and reassembles it into a format appropriate for standard media on computer systems. Although the data will typically be compressed, the invention does not need to uncompress the data in order to reassemble it into a format appropriate for standard media on computer systems.

Similarly, the invention also provides a method for first receiving data in a format appropriate for a real time transport protocol and then reassembling the data into a format appropriate for standard media on computer systems.

More specifically, the step of reassembling the data into a format appropriate for standard media on computer systems can be accomplished through first determining whether a frame of data contains audio or video data, then buffering the audio data or video data, as appropriate. Data is then created in a format appropriate for standard media on computer systems. Although the formatted data always includes the buffered audio, it only includes the buffered video if it is determined that buffered video data should be included for synchronization purposes. Once the data is properly formatted and reassembled, it can then be sent as an e-mail attachment or stored on a server.

### BRIEF DESCRIPTION OF THE DRAWINGS

FIG. 1 is a prior art diagram of a videoconferencing network;

FIG. 2A is a prior art block diagram showing the inputs and outputs of a videoconferencing unit;

FIG. 2B is a prior art block diagram showing the organization of a stream of RTP data;

FIG. 3A is a diagram of a videoconferencing network set up in accordance with one embodiment of the invention;

FIG. 3B is a diagram of a videoconferencing network set up in accordance with another embodiment of the invention;

FIG. 3C is a diagram of a videoconferencing network set up in accordance with another embodiment of the invention;

FIG. 4 is a block diagram generally describing the inputs and outputs of a system implementing the invention; and

FIG. 5 is a flowchart showing how data is reassembled into a format appropriate for standard digital media.

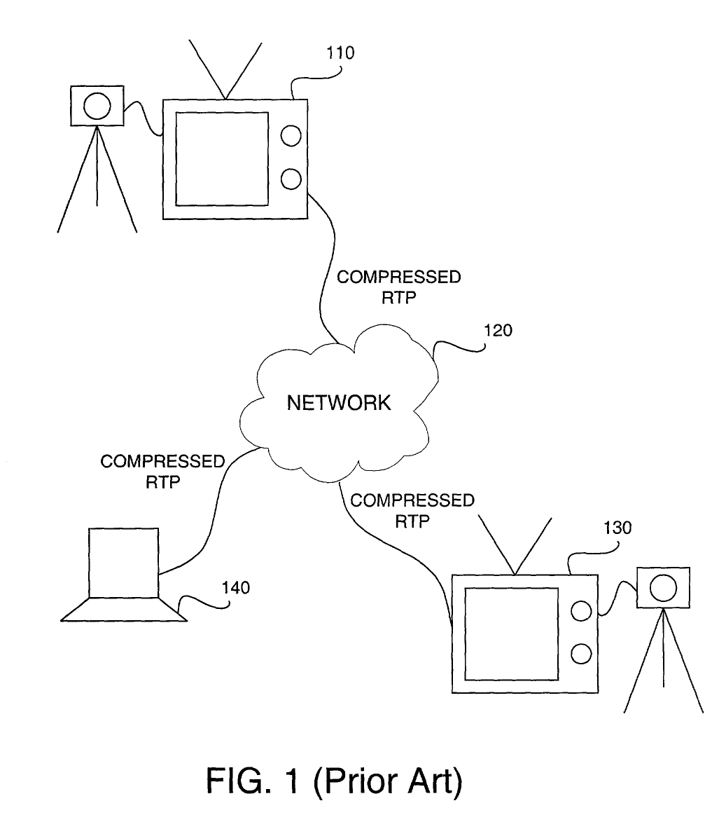

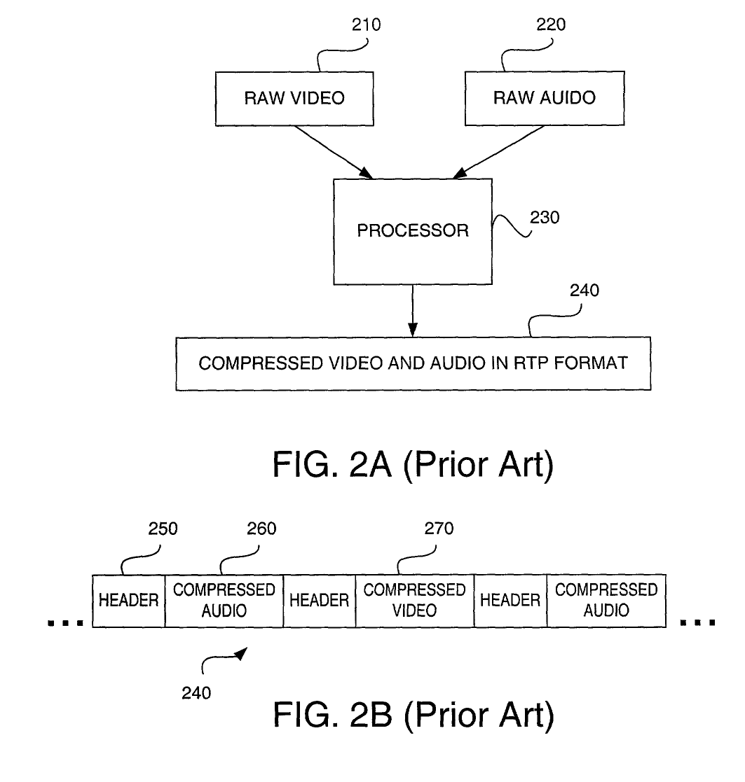

### DETAILED DESCRIPTION OF THE INVENTION

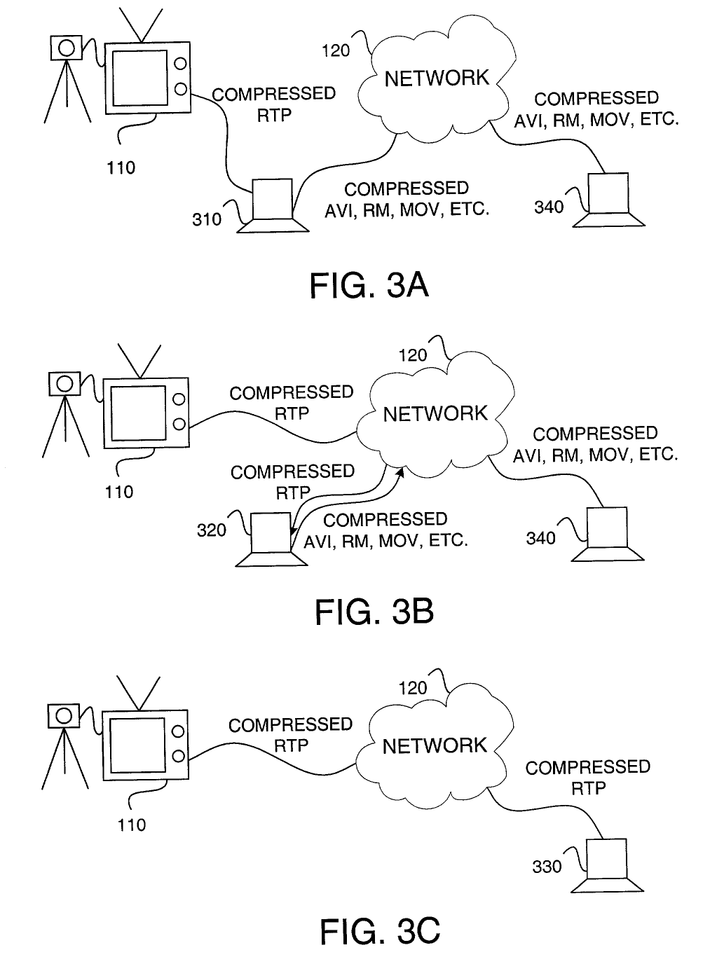

FIGS. 3A-3C are diagrams of a videoconferencing networks set up in accordance with various embodiment of the invention. In each diagram, prior art videoconferencing endpoint 110 is used to generate a RTP stream 240 of audio 260 and video data 270. A computer system 310, 320 or 330 then converts RTP stream 240 into a format appropriate for standard media on computer systems so the end user can view the content on a standard computer 340.

FIG. 3A shows a local computer system 310 connected directly with videoconferencing endpoint 110. This configuration allows the sending party to store and modify the converted data file on their local system 310 before sending it via network 120 to the end user's computer 340. Although local computer system 310 and videoconferencing endpoint 110 are shown as separate units, a similar embodiment would combine the elements in a single system.

FIG. 3B shows a very similar system, except an external computer system 320 is connected with videoconferencing endpoint 110 through network 120. This configuration could be implemented in several ways. External system 320 could either perform all the same functions as local system 310 from FIG. 3A, or external system 320 could act solely as a storage server for the data formatted for standard media on computer systems. In the later case an additional system (not shown) would be needed to convert of data from RTP format to standard media on computer systems format and execute all related functions.

Functions related to converting the data include accessing the conversion application, initiating/terminating the application, storing the data and making the data available for the end user. Accessing the application could either be through a menu choice on the videoconferencing endpoint 110, launching a program from computer system 310, 320 or 330, or even as an automatic function when the sending party is unable to place a regular videoconference (e.g., the second videoconferencing endpoint 130 is off-line).

Methods of starting and stopping the application could include standard on-screen VCR-type controls (record/stop/play/pause/rewind/fast forward), use of buttons on the remote controls that accompany most videoconferencing units, countdowns that warn the sending party that a session is about to begin, and terminating the session when a certain key (or any key) is pressed, or after a predetermined length of time.

Storage of the data can be either locally (FIG. 3A) or on an external server (FIG. 3B). As will be seen, the conversion to standard media on computer systems can be performed as soon as RTP data is received. Therefore, there is normally no need to save the RTP data. Additionally, the delivery mechanism will dictate further storage requirements.

For example, some embodiments would deliver the converted data to end users via e-mail. Once the complete message was converted, it could be stored on either the local processor 310 or the external processor 320. The sending party would then manually attach the converted file to an e-mail message.

An alternative method of sending the converted data via e-mail would be for the conversion application to automatically launch the sending party's e-mail program when the complete message was converted. The converted data file would then automatically be included as an attachment in the e-mail message. In this embodiment, the data file could be stored in volatile memory until the sending party delivers the e-mail.

More permanent storage would be required if, instead of delivering the entire media file to the end user via e-mail, only a hyperlink to the stored file was sent to the end user. For this embodiment, external server 320 shown in FIG. 3B is preferable to local system 310 shown in FIG. 3A. External system 320 could act as a dedicated server, always being on and avoiding the security concerns associated with an end user accessing data files on local system 310.

Yet another delivery mechanism to the end user could involve real-time streaming. Once the data was converted to a standard media format, it could be sent off to the end user's system 340 for viewing. No storage would be required in this embodiment.

Of course, there may be reasons to save either the converted data or even the original RTP data, in any of the above embodiments beyond the minimum requirements of those embodiments.

FIG. 3C shows another embodiment where the end user's system 330 converts the data. Although the end use would not require any special media viewing software, the conversion application would be necessary. This type of embodiment would somewhat defeat the purpose of the end user being able to view the media content without needing any special software. The embodiment, however, is shown because there are no technical limitations to implementing the invention in this manner.

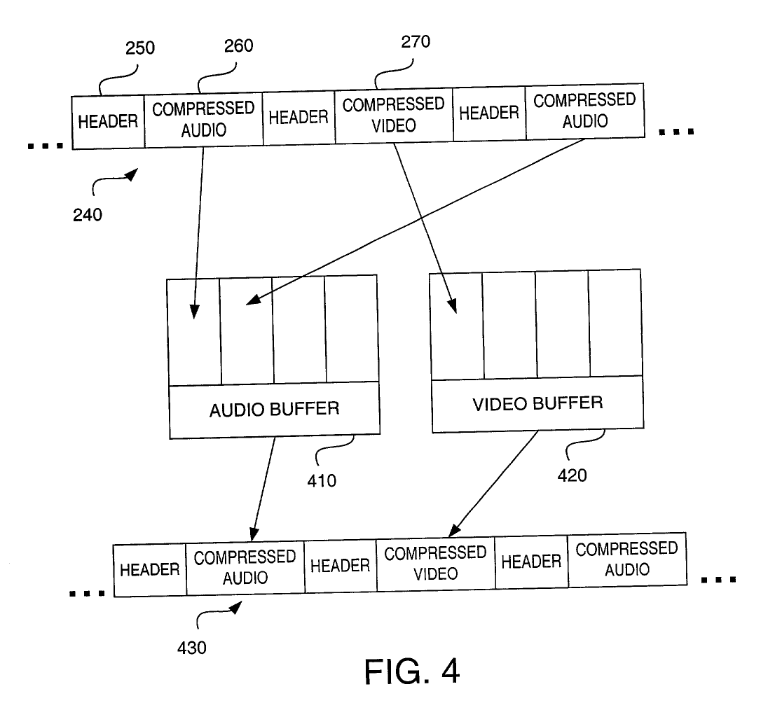

FIG. 4 is a block diagram generally describing the inputs and outputs of a system implementing the invention. As previously described, RTP data stream 240 contains header information 250, audio data 260, and video data 270. Audio 260 and video data 270 are typically compressed in accordance with the H.263 compression standard.

The compressed audio and video data are first temporarily stored in a buffer 410 and 420. A data stream formatted for standard media on computer systems 430 is then created using buffered audio 410 and buffered video 420. Although both the size of the audio and video packets and the headers are changed, the actual audio and video data, including any compression scheme (such as H.263), are not modified. Therefore, the reassembly of audio and video into a format appropriate for standard media on computer systems occurs very rapidly.

Although the RTP data stream 240 is shown in FIG. 4 as a single stream with multiplexed audio 260 and video data 270, one skilled in the art should readily appreciate that the process could easily be applied to systems where audio and video media are transmitted as separate RTP sessions, using two different UDP port pairs and/or multicast addresses.

FIG. 5 is a flowchart showing how data is reassembled into a format appropriate for standard digital media. Step 510 first receives RTP data stream 240. Next, step 520 examines the header 250 to determine whether the current RTP frame is audio 260 or video data 270. If the RTP frame is video 270, step 530 buffers the data 270 in the video data buffer 420. If the RTP frame is audio 260, step 540 buffers the data 260 in the audio data buffer 410.

Step 550 determines whether the audio data completes a frame in standard media format. The particular format will dictate how large the frame should be. Since the audio data arrives at a constant speed, the audio data can also serve as a benchmark for when a frame is complete in step 550. Once complete, step 560 creates standard media formatted data with the buffered audio frame. Header information specific to the particular format is also created in this step.

Step 570 then analyzes the timestamp associated with the buffered video data. If the video data arrived in time, step 580 uses the buffered video to create standard media formatted data, including header information. If the video data did not arrive in time, step 590 creates an empty frame for use in the standard media formatted data. Finally, step 595 determines whether to continue the process.

Although the invention has been described in its currently contemplated best mode, it is clear that it is susceptible to numerous modifications modes of operation and embodiments, all within the ability and skill and skill of those familiar with the art and within the exercise of further inventive activity. Accordingly, that which is intended to be protected by this patent is set forth in the claims and includes all variations and modifications that fall within the spirit and scope of the invention.

We claim:

1 A system, comprising:
a videoconferencing unit that creates data in a format appropriate for a real time transport protocol; and
a processor that receives the data and reassembles the data into a format appropriate for standard media on computer systems.

2 The system of claim 1, wherein the data is compressed.

3 The system of claim 1, wherein the data is compressed with H.263 format.

4 The system of claim 1, wherein the reassembled data can be delivered as an email attachment.

5 The system of claim 1, wherein the reassembled data is stored on a server.

6 A processor, comprising:
an input for receiving videoconferencing data in a format appropriate for a real time transport protocol; and
an output for delivering data reassembled into a format appropriate for standard media on computer systems.

7 A method, comprising the steps of:
receiving data in a format appropriate for a real time transport protocol; and
reassembling the data into a format appropriate for standard media on computer systems.

8 The method of claim 7, wherein the step of reassembling the data into a format appropriate for standard media on computer systems is accomplished through the steps of:
determining whether a frame of data appropriate for a real time transport protocol contains audio or video data;
buffering audio data when a frame of data contains audio data;
buffering video data when a frame of data contains video data;
creating data in a format appropriate for standard media on computer systems that includes the buffed audio data;
determining whether data in a format appropriate for standard media on computer systems should include the buffed video data; and
creating data in a format appropriate for standard media on computer systems that includes the buffed video data if it is determined that the buffered video data should be included.

9 The method of claim 7, wherein the data is compressed.

10 The method of claim 8, wherein the data is compressed.

11 The method of claim 7, wherein the data is compressed with H.263 format.

12 The method of claim 8, wherein the data is compressed with H.263 format.

13 The method of claim 12, further comprising the step of creating data in a format appropriate for standard media on computer systems that includes an empty video frame command if it is determined that buffered video data should not be included.

14 The method of claim 7, further comprising the steps of causing the reassembled data to be stored on a server.

15 The method of claim 8, further comprising the steps of causing the reassembled data to be stored on a server.

16 The method of claim 14, further comprising the step of creating an e-mail that includes a hyperlink to the reassembled data stored on the server.

17 The method of claim 15, further comprising the step of creating an e-mail that includes a hyperlink to the reassembled data stored on the server.

18 The method of claim 7, further comprising the step of creating an e-mail that includes the reassembled data as an attachment.

19 The method of claim 8, further comprising the step of creating an e-mail that includes the reassembled data as an attachment.

20 The method of claim 7, wherein the data received in a format appropriate for a real time transport protocol is generated in response to a failed attempt at a videoconference.

21 The method of claim 8, wherein the data received in a format appropriate for a real time transport protocol is generated in response to a failed attempt at a videoconference.
